(19) United States
(12) Patent Application Publication
(10) Pub. No.: US 2010/0287795 A1
(43) Pub. Date: Nov. 18, 2010

(54) AN ARTICLE OF FOOTWEAR

(76) Inventor: Michael Van Niekerk, Tasmania (AU)

Correspondence Address: LADAS & PARRY LLP, 224 SOUTH MICHIGAN AVENUE, SUITE 1600, CHICAGO, IL, 60604, US

(21) Appl. No.: 12/680,649

(22) PCT Filed: May 21, 2008
(86) PCT No.: PCT/AU08/00715

§ 371 Date: Jul. 20, 2010

(30) Foreign Application Priority Data
Sep. 28, 2007 (AU) 2007905332

(51) Int. Cl. A43B 13/14; A43B 13/38; B29C 45/18

(52) U.S. Cl. 36/25 R; 36/43; 264/328.8

(57) ABSTRACT

A method of injection moulding a sole or a part of the sole of an article of footwear from an expandable material is disclosed. The method is characterised by forming a mould chamber that has at least a main sub-chamber and at least one other sub-chamber and injecting controlled amounts of the expandable material into the sub-chambers so that the sole is formed with different densities of the same expanded material in the sub-chambers.

The present invention relates to an article of footwear and to a method of manufacturing the footwear article.

The present invention relates to safety and non-safety articles of footwear.

In particular, the present invention relates to a sole of an article of footwear and to a method of injection moulding the sole from an expandable material.

The term “expandable material” is understood herein to mean a material that can form a blown structure.

The term “expandable material” includes bi-component reactive materials that expand within a closed chamber. Polyurethane is an example of such a material.

The term “sole” is understood herein to include, by way of example, soles formed with a single density and soles formed with multiple densities, i.e. with an outer sole and a mid-sole of different densities.

There has been considerable effort to improve the comfort of footwear.

Improved comfort is a particular issue for safety footwear which, necessarily, often includes protective elements such as steel toe-caps that increase the weight of the footwear and is often worn for long periods of time and is used in difficult terrains.

It is known to improve footwear comfort by providing “foreign” bodies of lower density in the main areas of impact of footwear with a ground surface, such as ball and heel areas of footwear.

In the case of footwear that is injection moulded from polyurethane, it is known to use blocks or other suitably shaped bodies of lower density materials, such as

“Poron”™ microcellular urethane foams as inserts in footwear soles.

The use of “foreign” bodies as inserts in soles cannot readily be accommodated in standard technology for injection moulding soles from polyurethane.

In addition, the use of “foreign” bodies as inserts reduces the torsional stability of footwear articles. The reduction in torsional stability is due to the “foreign” bodies essentially being separate structurally to the remainder of the soles of the footwear article.

The present invention provides a sole that provides improved comfort for the footwear article without the use of the above-mentioned “foreign” bodies.

The present invention makes it possible to form the footwear article with different densities of the same injection moulded material in different parts of the sole from one material in a single injection moulding step. The different densities provide an opportunity to have lower densities in areas of the footwear article that are important from the comfort viewpoint, such as the heel and ball sections of the article. Providing such lower densities is an advantage from this viewpoint.

The present invention also makes it possible to lower the overall density of moulded material in the sole of the footwear article. This is an advantage in terms of reducing the weight of the footwear article and the amount of expandable material such as polyurethane required to manufacture the footwear article.

In addition, the present invention makes it possible to improve the impact performance of the footwear article in the toe section of the article. This is particularly important for safety footwear.

In general terms the present invention provides a method of injection moulding a sole or a part of the sole of an article of footwear from an expandable material is disclosed. The method is characterised by forming a mould chamber that has at least a main sub-chamber and at least one other sub-chamber and injecting controlled amounts of the expandable material into the sub-chambers so that the sole is formed with different densities of the same expanded material in the sub-chambers.

Preferably the mould chamber is defined by a mould that comprises an upper mould half and a lower mould half.

Preferably the mould comprises a wall that divides the mould chamber into at least two sub-chambers.

Preferably the dividing wall has a series of openings to allow expandable material to flow from one sub-chamber into the other sub-chamber.

The dividing wall may be defined by an insert that can be positioned in the mould chamber.

The dividing wall may also be a part of the mould. For example, in a case of injection moulding a mid-sole of a footwear sole that also comprises an outer sole and an inner sole, with the outer and inner soles defining upper and lower mould halves, respectively, the inner sole may be formed with the dividing wall as a part of the inner sole or connected to the inner sole.

In a situation where the method is concerned with injection moulding a mid-sole of the footwear article, preferably the upper mould half comprises a lasted upper assembly that comprises an inner sole and an upper of the footwear article and the lower mould half comprises an outer sole of the footwear article.

The method may comprise providing the dividing wall in a part of the mould chamber that forms the heel section and/or the ball section of the footwear article.

Preferably the method comprises providing the dividing wall at least in a part of the mould chamber that forms the ball section of the footwear article.

It is particularly preferred that the method comprises providing the dividing wall in a part of the mould chamber that forms the ball section and the toe section of the footwear article.

The method may comprise providing the dividing wall so that it extends across the width of and along the whole of the length of the mould chamber.

In one embodiment the method comprises injecting the expandable material into the main sub-chamber so that it forms a pool on the lower mould half when the mould is in a first closed position and moving the mould into a second closed position and bringing the dividing wall into contact with the injected expandable material so that a controlled amount of the material flows through the openings in the dividing wall into the other sub-chamber, with the result that the densities of the expanded material in the sub-chambers are different.

Preferably movement of the mould into the second closed position forces the material out to the extremities of the mould chamber, i.e. to areas that are away from the injection point or points for expandable material into the mould. This is an advantageous when compared to the current practice because it ensures that the expandable material is distributed through the whole of the mould chamber and reduces the extent to which the expandable material has to blow in order to completely fill the mould chamber. Hence, less expandable material is required and there is a lower overall density of the sole.

Preferably the dividing wall is positioned in the mould chamber so that moving the mould into the second closed position forces the expandable material quickly to the extremities of the mould chamber, i.e. to areas that are away from the injection point or points for expandable material into the mould, when the mould is moved to the second closed position.

Preferably the method comprises injecting the material into the main sub-chamber and then moving the lower mould half towards the upper mould half and thereby moving the mould from the first closed position to the second closed position, whereby the relative movement of the mould halves brings the dividing wall into contact with the material in the main sub-chamber and forces (a) at least a part of the expandable material outwardly to the sides and (b) a controlled amount of the material through the openings in the dividing wall from the main sub-chamber into the other sub-chamber.

In another embodiment the method comprises:
(a) positioning the insert on or in relation to the lower mould half when the mould is in an open position;
(b) closing the mould to a first closed position;
(c) injecting the expandable material into the mould so that a selected amount of the material is deposited in the main sub-chamber and the remainder of the material is deposited in the other sub-chamber;
(d) closing the mould to a second closed position, and
(e) allowing the material to expand and occupy the volume of the mould chamber and thereby form the sole or the part of the sole, with the result that the densities of the expanded material in the sub-chambers are different.

Step (a) may include positioning the insert on or in relation to the lower mould half so that the insert extends into the mould chamber and is in a path of injection of at least some of the expandable material into the mould chamber in step (c) of the method, whereby a downwardly facing surface of the insert is in the line of injection of the material in step (c) of the method, and whereby a selected amount of the injected material flows through the opening or openings in the insert onto an upwardly facing surface of the insert when contacted by the injected material in step (c) of the method.

With this arrangement, preferably step (c) of the method comprises, after completing injection of the material, moving the lower mould half and the upper mould half towards each other and thereby moving the mould from the first closed position to the second closed position and thereby forming the sub-chambers within the mould chamber, with both sub-chambers containing the injected material.

Preferably the insert comprises at least one locating pin at one end of the insert and the lower mould half comprises at least one socket for receiving the pin, and step (a) comprises positioning the insert so that the pin is received in the socket and the insert is thereby retained in position by the lower mould half and extends upwardly into the mould chamber.

Preferably the pin and the socket are formed so that the insert extends upwardly into the mould chamber from the plane of the lower mould half at an angle of 30-60° to the plane.

Preferably, moving the mould to the second closed position brings the insert into contact with the upper mould half and causes the insert to deflect towards the lower mould half and thereby forms the sub-chambers.

Preferably the insert has a base and a side wall extending from the base.

Preferably the insert comprises a flange that extends from the side wall of the insert to contact the upper mould half when the upper mould half and the lower mould half are moved to the second closed position and form the sub-chamber in step (c) of the method.

The openings may be in the base or the side wall of the insert.

Preferably the insert includes a plurality of openings in the base of the insert.

Preferably the insert comprises a forward section that, when the insert is positioned in the mould chamber, is in a toe section of the mould chamber.

Preferably the forward section of the insert is adapted to be positioned directly underneath a toe-cap of the footwear article.

Preferably the forward section of the insert comprises at least one opening to allow expandable material to flow/expand through the opening.

According to the present invention there is also provided a sole made by the above-described injection moulding method.

Preferably the sole comprises an outer sole, an insole, and a mid-sole between the outer sole and the insole.

According to the present invention there is also provided an insert for use as a part of a sole of an article of footwear including a base, a side wall, one or more than one opening in the base and/or the side wall.

Preferably the insert comprises a flange that extends from the side wall of the insert.

The openings may be in the base or the side wall of the insert.

Preferably the insert comprises a plurality of openings in the base of the insert.

Preferably the openings are in the form of a plurality of slots that, when the insert is positioned in a mould chamber, extend transversely to the longitudinal axis of the footwear article being manufactured, i.e. the axis that extends between forward and rearward ends of the footwear article.

Preferably the base of the insert comprises a plurality of ribs that, when the insert is positioned in a mould chamber, extend transversely to the longitudinal axis of the footwear article. The ribs are provided as a structural feature to assist in maintaining the shape of the insert during the above-described method. Positioning the ribs transversely provides the structural performance without affecting the capacity of the insert to bend about a transverse axis, as is required during normal walking activity.

Preferably the insert comprises a forward section that, when the insert is positioned in a mould chamber, is in a toe section of the mould chamber.

Preferably the forward section of the insert is adapted to be positioned directly underneath a toe-cap of the footwear article.

Preferably the forward section of the insert comprises at least one opening to allow expandable material to flow/expand through the opening. Providing the opening ensures that there is direct contact between expandable material and an insole of the article of footwear.

Preferably the insert is made from a material that can form a bond with the expandable material.

The insert may comprise legs that can support the insert in an inclined position in a closed mould chamber with the insert positioned on a base of the mould chamber.

According to the present invention there is also provided a lasted assembly that comprises an insole and an upper positioned on a last and the above-described insert glued or otherwise secured to the insole.

According to the present invention there is provided a method of injection moulding a sole of an article of footwear that includes:

(a) injection moulding an outer sole; and

(b) injection moulding a mid-sole in accordance with the above-described method.

According to the present invention there is also provided a method of injection moulding a sole or a part of the sole, such as a mid-sole, of an article of footwear in a mould having a mould chamber, the method being characterised by forming the mould so that a section of the mould that defines at least a ball section of the footwear article is formed so that expandable material that is injected into the mould chamber during the method is forced out to the extremities of the mould as the mould chamber is moved into a closed position.

The present invention is described further by way of example with reference to the accompanying drawings of which:

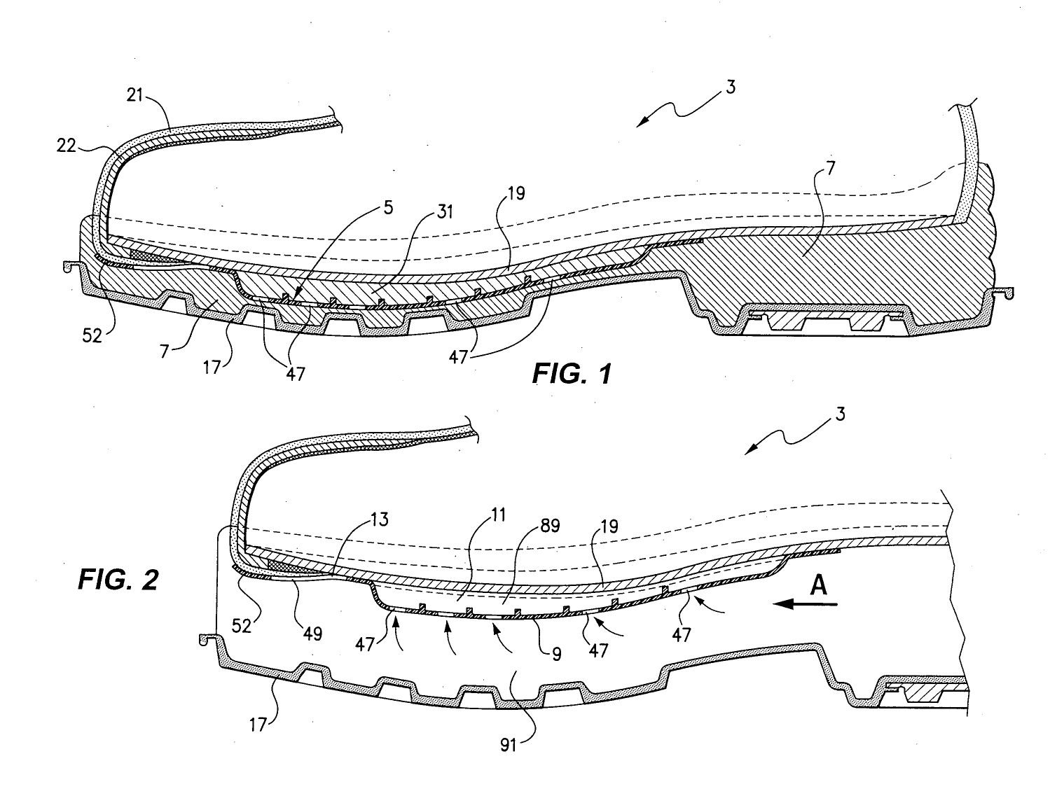

FIG. 1 is a vertical cross-section of an embodiment of an article of footwear in accordance with the present invention which shows the position of an insert in a mid-sole of the footwear article;

FIG. 2 is a vertical cross-section of a forward part of a mould for injection moulding the footwear article in FIG. 1 in a first closed position of the mould prior to injecting expandable material, such as polyurethane, into the mould, the mould comprising an upper mould half in the form of an assembly of an inner sole and an upper of the footwear article and a lower mould half of an outer sole of the footwear article;

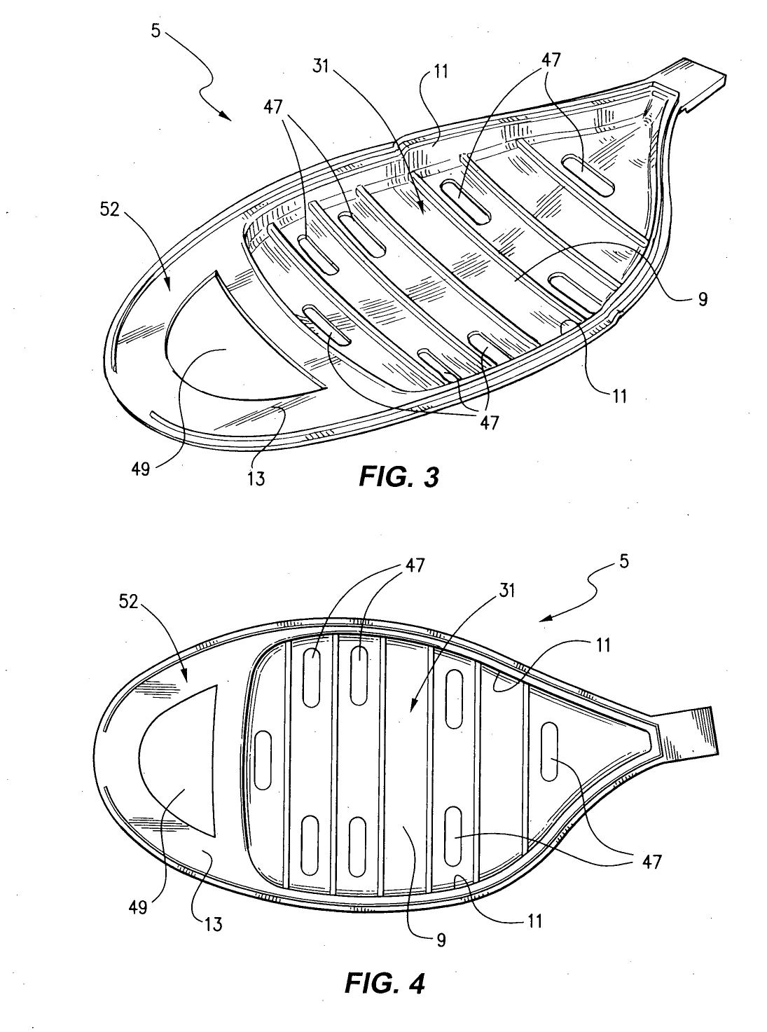

FIG. 3 is a perspective view of one embodiment of an insert in accordance with the present invention that forms part of the footwear article shown in FIG. 1;

FIG. 4 is a top plan view of the insert shown in FIG. 3;

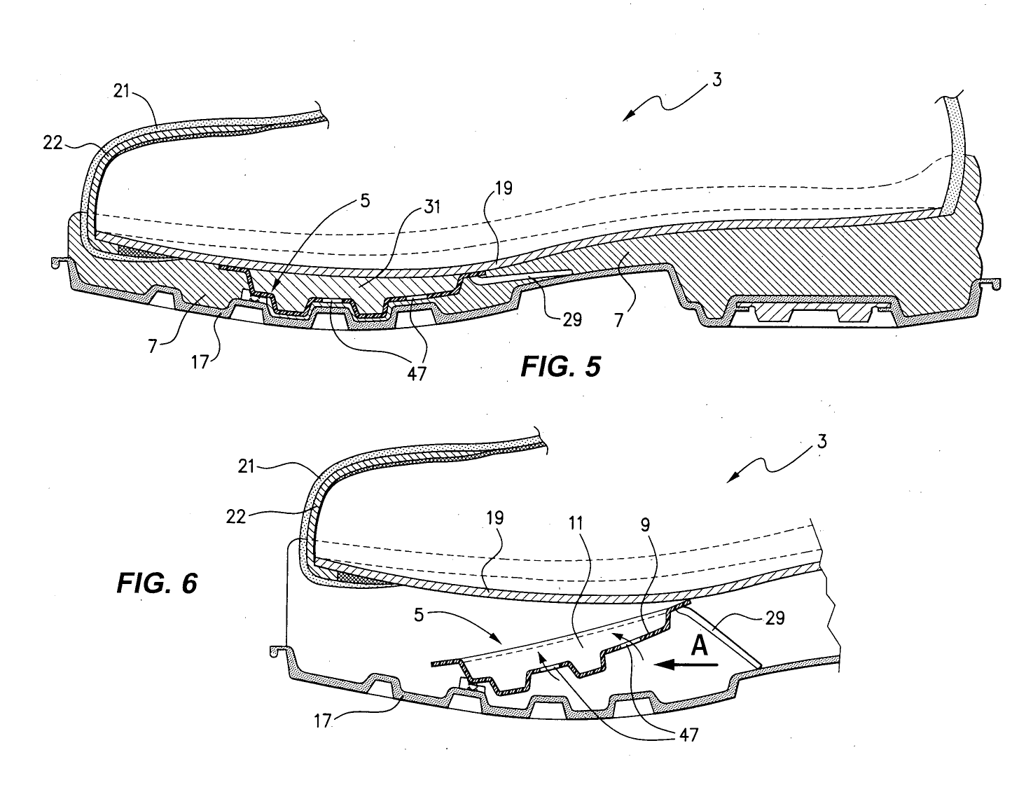

FIG. 5 is a vertical cross-section of another, although not the only other, embodiment of an article of footwear in accordance with the present invention which shows the position of an insert in a mid-sole of the footwear article;

FIG. 6 is a vertical cross-section of a forward part of a mould for injection moulding the footwear article in FIG. 5 in a first closed position of the mould prior to injecting expandable material, such as polyurethane, into the mould, the mould comprising an upper mould half in the form of an assembly of an inner sole and an upper of the footwear article and a lower mould half of an outer sole of the footwear article;

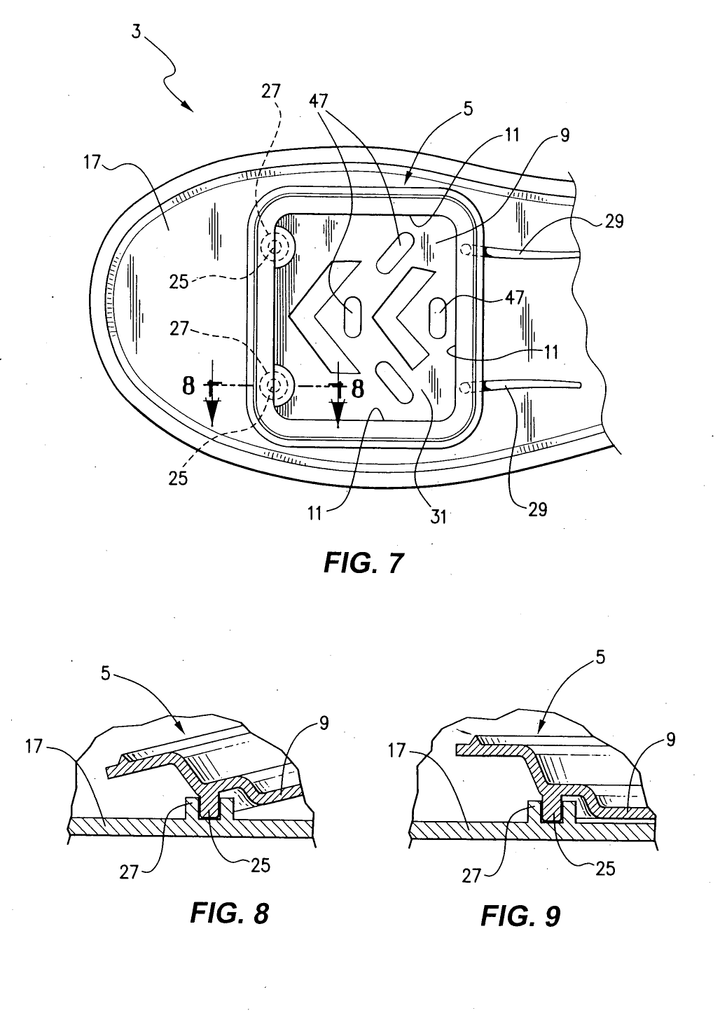

FIG. 7 is a top plan view of the forward part of the outer sole of the footwear article shown in FIG. 5 which shows the insert positioned on the outer sole in the mould;

FIG. 8 is a cross-section along the line 8-8 of FIG. 7 which shows the engagement of a pin of the insert in an upstanding socket of the outer sole;

FIG. 9 is a cross-section similar to that shown in FIG. 8 but showing the assembly in a second closed position of the mould.

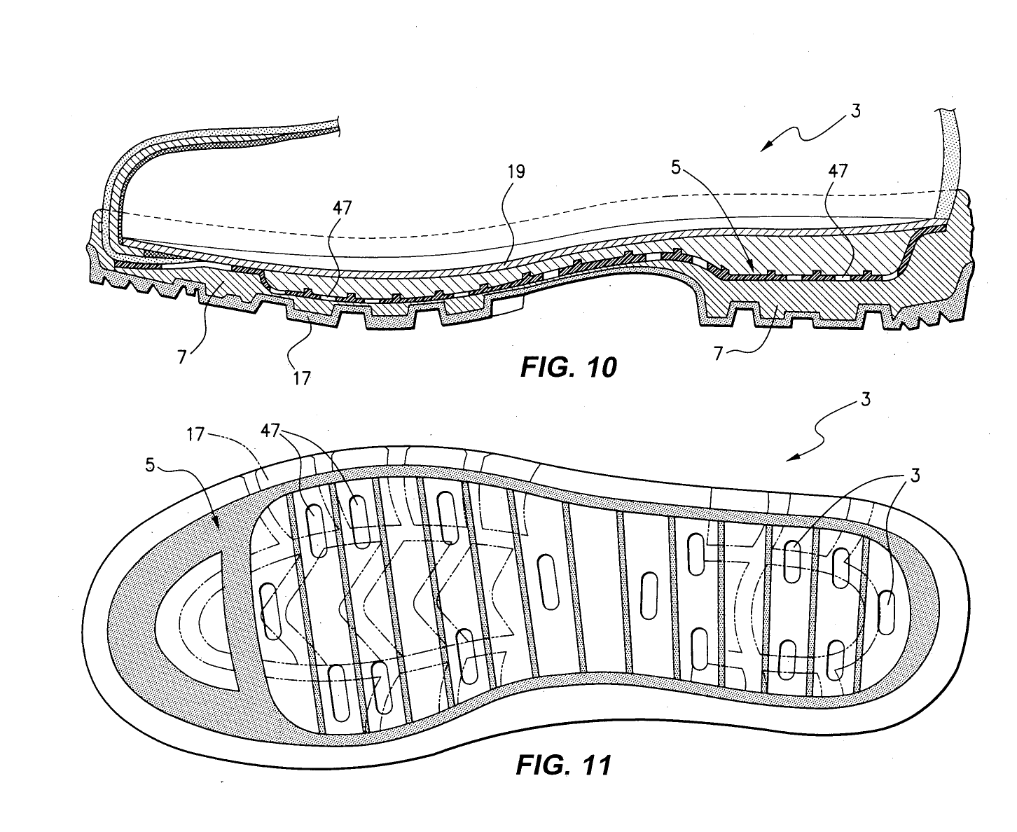

FIG. 10 is a vertical cross-section of another, although not the only other, embodiment of an article of footwear in accordance with the present invention which shows the position of an insert in a mid-sole of the footwear article; and

FIG. 11 is a top plan view of one embodiment of an insert in accordance with the present invention that forms part of the footwear article shown in FIG. 10, with the insert shown positioned on an outer sole of the footwear article.

As is indicated above, FIG. 1 is a vertical cross-section of one embodiment of an article of footwear 3, such as a safety boot, in accordance with the present invention which shows the position of a dividing wall in the form of an insert 5 in a mid-sole 7 of the footwear article.

The footwear article 3 also comprises an outer sole 17, an inner sole 19, an upper 21 connected to the inner sole 19, and a steel toe-cap 22.

The mid-sole 7 and the outer sole 17 are both formed from polyurethane. The outer sole 17 is formed from a high density polyurethane that provides wear resistance and puncture resistance. The mid-sole 7 is formed from lower density polyurethane.

The insert 5 is positioned in the forepart of the mid-sole 7 which includes the ball and the toe sections of the footwear article 3. The insert 5 is also positioned partially in the instep of the footwear article.

The insert 5 forms a dividing wall that divides the polyurethane in the mid-sole 7 into two regions, with the polyurethane in a region 31 of the mid-sole 7 being a lower density than the polyurethane in the remainder of the mid-sole 7. The region 31 is defined by the insert 5 and a section of the inner sole 19 that is contacted by a ball of the foot of a person wearing the footwear article 3. The lower density polyurethane in the ball section of the inner sole 19 improves the performance, specifically the comfort, of the footwear article 3.

The mid-sole 7 is a lamination of the insert 5 and the above-described regions of the expanded material. Typically, the insert 5 is manufactured from a material such as TPU that can bond with the polyurethane.

The applicant has found that the lamination is a unified structure that has high torsional stability. This is a significant advantage when compared with the lack of torsional stability with known footwear articles that have “foreign” bodies as inserts in the soles of the footwear articles.

The different densities of the polyurethane in the mid-sole 7 are formed by injection moulding the same polyurethane material into a mould in an injection moulding machine in accordance with one embodiment of the present invention.

The method depends in large part on the construction and location of the insert 5 and the injection moulding conditions.

With reference to FIGS. 3 and 4, the footprint of the forward part of the insert 5 (as viewed in the Figures) is shaped to conform generally to the shape of the forward part of the footwear article 3. The insert 5 comprises a base 9 having a plurality of openings in the form of slots 47, a side wall 11 extending from the base 9, and a flange 13 extending outwardly from the side wall 11.

The forward part of the flange 13 of the insert 5 is shaped to conform to the toe-cap 22 of the footwear article 3. The forward part includes a central opening 49 that allows polyurethane to expand through the opening. This is important in terms of bonding the mid-sole 7 to the inner sole 19 of the footwear article 3. The forward part also defines a platform 52 that, in use, is positioned immediately below the steel toe-cap of the footwear article 3. Typically, the surface area of the platform 49 is greater than the area of the contact footprint of the toe-cap. The applicant has found that providing the platform 51 so that it is immediately below the steel toe-cap 22 is an advantage in terms of impact performance of the footwear article 3. Specifically, the applicant has found that the platform 51 distributes the downward force generated on impact on a toe-cap through the insert 5 and this reduces downward movement of the toe-cap into the mid-sole 7, and thereby reduces the possibility of crushing of toes or damage as a result of the impact.

One embodiment of the method of forming the dual density polyurethane mid-sole 7 shown in FIG. 1 comprises the following basic steps carried out in an injection moulding machine (not shown).
Forming the outer sole 19 of the footwear article 3 by injecting an expandable material in the form of a high density polyurethane into a first mould of the machine.
Adhering or otherwise connecting the insert 5 to an inner sole 19 of a lasted upper assembly which comprises the inner sole 19 and the upper 21 of the footwear article 3, and thereby forming a sub-chamber 89 defined by the insert 5 and the lasted upper assembly which ultimately forms the region 31 shown in FIG. 1.
Positioning the lasted upper assembly with the connected insert 5 above the outer sole 17 as shown in FIG. 2, whereby the lasted upper assembly and the outer sole 17 define respective upper and lower mould halves of a mould. In this arrangement, the insert 5 extends into the mould chamber defined by the mould halves. In effect, the mould chamber comprises a main sub-chamber 91 and the sub-chamber 89.
Forming the mid-sole 7 of the footwear article 3 by injecting polyurethane into the mould. One option for this step involves closing the mould to a first closed position shown in FIG. 2, injecting polyurethane into the main sub-chamber 91 in the direction of the arrow “A” in FIG. 2 so that the material forms a pool on the outer sole 17 (without contacting the insert 5), moving the lasted upper assembly and the outer sole 17 relative to each other to close the mould to a second closed position (not shown), thereby bringing the base 9 of the insert 5 into contact with the pool of polyurethane and forcing the polyurethane to the extremities of the mould and through the openings 47 into the sub-chamber 89. Thereafter, the polyurethane blows to expand in the sub-chambers 89, 91 and forms the mid-sole 7. Forcing the polyurethane into the sub-chamber 89 via the openings 47 in the insert 5 provides an opportunity to selectively control the densities of the blown polyurethane in both sub-chambers, with the result that the region 31 of the footwear article 3 shown in FIG. 1 can have a lower density than the remainder of the mid sole 7.
Specifically, the construction of the insert 5 (such as size and location of openings 47 in the insert 5) and injection conditions (such as the amount of injected material and the injection direction) are controlled so that the amounts of polyurethane in the sub-chambers 89, 91 produce a mid-sole 7 with different densities. In addition, forcing the polyurethane outwardly to the extremities of the mould reduces the extent to which it is necessary to blow the polyurethane. This means that less polyurethane is required than is usually the case. In addition, this means that it is possible to form the mid-sole 7 with an overall lower density than is currently the case. Specifically, the applicant has found that the overall density can be reduced from current levels of 0.47/0.50sg to 0.42/0.47sg.

The embodiment of the footwear article 3 shown in FIGS. 5 to 9 is similar to the footwear article 3 shown in FIGS. 1 to 4 and the same reference numerals are used to describe the same features in the Figures.

The footwear article 3 comprises a mid-sole 7 that has an insert 5 as a part of the mid-sole 7, an outer sole 17, an inner sole 19, an upper 21 connected to the inner sole 19, and a steel toe-cap 22.

The mid-sole 7 and the outer sole 17 are both formed from polyurethane. The outer sole 17 is formed from a high density polyurethane that provides wear resistance and puncture resistance. The mid-sole 7 is formed from lower density polyurethane, with the polyurethane in the region 31 of the mid-sole 7 being a lower density than the polyurethane in the remainder of the mid-sole 7. The region 31 of the mid-sole 7 is defined by the insert 5 and a section of the inner sole 19 that is contacted by a ball of the foot of a person wearing the footwear article 3. The lower density polyurethane in the ball section of the inner sole 19 improves the performance of the footwear article 3.

The insert 5 comprises a generally square base 9 having a plurality of small openings (not shown), a side wall 11 extending from the base 9, an outwardly extending flange 13, and a plurality of small openings (not shown) in the base 9.

The insert 5 also comprises a pair of pins 25 that depend downwardly from a lower surface of the base 9 at a forward end (as shown in the Figures) of the insert 5. As can best be seen in FIGS. 6-8, the pins 25 are provided to cooperate with upwardly opening sockets 27 in an upper surface of the outer sole 17 to support the insert 5 in relation to the outer sole 17 so that the insert extends upwardly into a mould chamber in a first closed position of the mould (as shown in FIG. 6) prior to injecting polyurethane or other expandable material in an injection moulding step for forming the mid-sole 7, discussed hereinafter. The arrangement is such that the insert 5 extends upwardly from the outer sole 17 at an angle of the order of 30° from the plane of the outer sole 17 (as shown in FIGS. 6 and 8) prior to the injection moulding step.

As can best be seen in FIG. 6, the insert 5 also comprises a pair of legs 29 that depend downwardly from a lower surface of the base 9 at a rearward end (as shown in the Figures) of the insert 5. The legs 25 are provided to contribute to positioning the insert 5 in the first closed position of the mould, which is in effect a pre-moulding operative position, shown in FIG. 6. The insert 5 can be conveniently moulded from a polymeric material.

One embodiment of the method of forming the dual density polyurethane mid-sole 7 shown in the Figures comprises the following basic steps carried out in an injection moulding machine.
Forming the outer sole 19 of the footwear article 3 by injecting an expandable material in the form of a high density polyurethane into a first mould of the machine.
Inserting the pins 25 of the insert 5 into the sockets 27 of the outer sole 19 and thereby positioning the insert 5 in relation to the outer sole 19, as shown in FIG. 6.
Positioning a lasted upper assembly (which comprises the inner sole 19 and the upper 21) of the footwear article 3 above the outer sole 19 as shown in FIG. 6, whereby the lasted upper assembly and the outer sole 17 define respective upper and lower mould halves of a mould.
Forming the mid-sole 7 of the footwear article 3 by injecting polyurethane into the mould. One option for this step involves positioning the insert 5 on the outer sole 17 so that the insert 5 extends upwardly from the outer sole 17 into the mould chamber prior to closing the mould to a first closed position, closing the mould to the first closed position shown in FIG. 6, injecting polyurethane into the mould chamber in the direction of the arrow “A” in FIG. 6 so that some of the material contacts a downwardly facing surface of the insert 5 and a controlled amount of the material flows through the openings 47 in the insert 5 onto an upwardly facing surface of the insert 5, moving the lasted upper assembly and the outer sole 17 relative to each other to close the mould to a second closed position and thereby forming a sub-chamber defined by the insert 5 and the lasted upper assembly (as shown in part in FIG. 9), and allowing the polyurethane to blow to expand into the sub-chamber and the main of the mould and form the mid-sole 7. The construction of the insert 5 (such as size and location of openings in the insert 5) and injection conditions (such as the amount of injected material and the injection direction) are controlled so that the amounts of polyurethane in the sub-chamber and the remainder of the mould produce different densities.

The embodiment of the footwear article 3 shown in FIGS. 10 and 11 is very similar to the footwear article 3 shown in FIGS. 1 to 4 and the same reference numerals are used to describe the same features in the Figures.

With reference to FIGS. 10 and 11, the only difference between the footwear article 3 shown in these Figures and the footwear article 3 shown in FIGS. 1 to 4 is that the insert 5 of the FIGS. 10/11 footwear article extends substantially across the whole of the width of the mid-sole 7 and substantially along the whole of the length of the mid-sole 7. The extent of the footprint of the insert 5 can be seen in FIG. 11. The Figure shows the insert 5 positioned on the outer sole 17 of the footwear article 3.

The embodiment of the method of forming the mid-sole 7 of the FIGS. 1 to 4 footwear article that is described above can be used to form the mid-sole 7 of the FIGS. 10/11 footwear article 3.

The above-described methods can readily be accommodated in standard technology for injection moulding soles from polyurethane. A significant advantage in this regard is that the methods can produce mid-soles 7 from one injected expandable material and the prior art “foreign” bodies discussed above are not required. In this connection, manufacturing the insert 5 from a material such as TPU that can bond with the polyurethane further contributes to the unitary nature of the sole.

Many modifications may be made to the embodiments of the present invention described above without departing from the spirit and scope of the present invention.

Whilst the embodiments are described in the context of manufacturing a mid-sole 7 of an article of footwear 3, the present invention is not so limited and can be used to manufacture soles generally, with the soles having dual densities produced from the same expandable material.

In addition, whilst the embodiments include the use of inserts 5 to define the sub-chambers in the mould chamber, the present invention is not so limited and extends to any suitable form of dividing wall that can divide a mould chamber into two or more than two chambers that ultimately can form regions of different densities in the mid-sole 7 formed from the same expandable material.

In addition, whilst the embodiments are described in the context of articles of safety footwear, the present invention is not so limited and is equally applicable to non-safety footwear.

1. A method of injection moulding a sole or a part of the sole of an article of footwear from an expandable material that is characterised by forming a mould chamber that has at least a main sub-chamber and at least one other sub-chamber and injecting controlled amounts of the expandable material into the sub-chambers so that the sole is formed with different densities of the same expanded material in the sub-chambers.

2. The method defined in claim 1 wherein the mould chamber is defined by a mould that comprises an upper mould half and a lower mould half and a wall that divides the mould chamber into at least two sub-chambers.

3. The method defined in claim 2 wherein the dividing wall has a series of openings to allow expandable material to flow from one sub-chamber into the other sub-chamber.

4. (canceled)

5. (canceled)

6. The method defined in claim 3 comprises injecting the expandable material into the main sub-chamber so that it forms a pool on the lower mould half when the mould is in a first closed position and moving the mould into a second closed position and bringing the dividing wall into contact with the injected expandable material so that a controlled amount of the material flows through the openings in the dividing wall into the other sub-chamber, with the result that the densities of the expanded material in the sub-chambers are different.

7. The method defined in claim 6 wherein moving the mould into the second closed position forces the material out to the extremities of the mould chamber, i.e. to areas that are away from the injection point or points for expandable material into the mould.

8. (canceled)

9. The method defined in claim 6 comprises injecting the material into the main sub-chamber and then moving the lower mould half towards the upper mould half and thereby moving the mould from the first closed position to the second closed position, whereby the relative movement of the mould halves brings the dividing wall into contact with the material in the main sub-chamber and forces (a) at least a part of the expandable material outwardly to the sides and (b) a controlled amount of the material through the openings in the dividing wall from the main sub-chamber into the other sub-chamber.

10. The method defined in claim 2 wherein the dividing wall is defined by an insert that can be positioned in the mould chamber and the method comprises:
(a) positioning the insert on or in relation to the lower mould half when the mould is in an open position;
(b) closing the mould to a first closed position;
(c) injecting the expandable material into the mould so that a selected amount of the material is deposited in the main sub-chamber and the remainder of the material is deposited in the other sub-chamber;
(d) closing the mould to a second closed position, and
(e) allowing the material to expand and occupy the volume of the mould chamber and thereby form the sole or the part of the sole, with the result that the densities of the expanded material in the sub-chambers are different.

11. The method defined in claim 10 wherein step (a) includes positioning the insert on or in relation to the lower mould half so that the insert extends into the mould chamber and is in a path of injection of at least some of the expandable material into the mould chamber in step (c), whereby a downwardly facing surface of the insert is in the line of injection of the material in step (c), and whereby a selected amount of the injected material flows through the opening or openings in the insert onto an upwardly facing surface of the insert when contacted by the injected material in step (c).

12. (canceled)

13. The method defined in claim 10 wherein the insert comprises at least one locating pin at one end of the insert and the lower mould half comprises at least one socket for receiving the pin, and step (a) comprises positioning the insert so that the pin is received in the socket and the insert is thereby retained in position by the lower mould half and extends upwardly into the mould chamber.

14. (canceled)

15. The method defined in claim 10 wherein moving the mould to the second closed position brings the insert into contact with the upper mould half and causes the insert to deflect towards the lower mould half and thereby forms the sub-chambers.

16-22. (canceled)

23. A sole made by the moulding method defined in claim 1.

24. (canceled)

25. An insert for use as a part of a sole of an article of footwear including a base, a side wall, one or more than one opening in the base and/or the side wall.

26. The insert defined in claim 25 comprises a flange that extends from the side wall of the insert.

27. The insert defined in claim 25 comprises a plurality of openings in the base of the insert.

28. The insert defined in claim 27 wherein the openings are in the form of a plurality of slots that, when the insert is positioned in a mould chamber, extend transversely to the longitudinal axis of the footwear article being manufactured, i.e. the axis that extends between forward and rearward ends of the footwear article.

29. The insert defined in claim 25 wherein the base comprises a plurality of ribs that, when the insert is positioned in a mould chamber, extend transversely to the longitudinal axis of the footwear article.

30. A method of injection moulding a sole of an article of footwear that includes:
(a) injection moulding an outer sole; and
(b) injection moulding a mid-sole in accordance with the method defined in claim 1.

31. A method of injection moulding a sole or a part of the sole, such as a mid-sole, of an article of footwear in a mould having a mould chamber, the method being characterised by forming the mould so that a section of the mould that defines at least a ball section of the footwear article is formed so that expandable material that is injected into the mould chamber during the method is forced out to the extremities of the mould as the mould chamber is moved into a closed position.
